(19) United States
(12) Patent Application Publication
(10) Pub. No.: US 2007/0009863 A1
(43) Pub. Date: Jan. 11, 2007

(54) Off-highway vehicle trail map directory

(76) Inventors: Alan S. Hart, Lakewood, CO (US); Charles K. Hart, Highlands Ranch, CO (US)

Correspondence Address: LAW OFFICE OF JOHN L. ISAAC, 7114 W. JEFFERSON AVE., SUITE 100, LAKEWOOD, CO, 80235-2309, US

(21) Appl. No.: 10/964,955

(22) Filed: Oct. 14, 2004

(51) Int. Cl. G09B 29/00

(52) U.S. Cl. 434/150

(57) ABSTRACT

A trail map directory for off-highway vehicles is disclosed. The directory includes a binder having a plurality of individual map pages laminated for dry ease writing and for ease of cleaning. A mechanism is provided for releasably attaching each map page to the binder. A key map is positioned towards the front of the binder, and the key map is subdivided into individual regional map display portions corresponding to the individual map pages. Each map page is preferably a substantially flat, relatively stiff laminated panel. The panel has first and second faces located on opposite surfaces thereof, and first and second side edges which define the width dimension of the panel. Each panel first face includes an enlarged map display portion indexed relative to the key map and is in the form of an enhanced topographical map overlaid with off-road trails present within the map boundary. The trails are color-coded to indicate relative difficulty of use. The first face further includes trail symbols relative to the indicated off-road trails. Each second face includes an index to trail symbols appearing on the first face. The second face may also include GPS coordinates pertinent to the geographical points on the topographical map as well as driving directions to the off-road trails. Finally, an apparatus is disposed along each panel first side edge for releasably attaching the panel to the binder for removal for individual use.

### BACKGROUND OF THE INVENTION

1. Field of the Invention

The present invention relates generally to back road trail maps and, more particularly, to off-highway trail map directories used by off-road vehicles and hikers. Specifically, the present invention relates to an improved off-highway trail map directory for use by vehicles such as 4×4's, ATV's, snowmobiles and the like and includes trail information pertinent to such use.

2. Description of the Prior Art

Trail books and maps are readily available for hikers and off-road vehicle enthusiasts. These books may be published by the National Forest Service or they may be created by private concerns. Typically, they include various non-paved roads and trails in general and may even include some topographic information to indicate steepness of the surrounding terrain. In addition, other information such as parking areas and the like may also be included. Unfortunately, these maps, while providing some guidance information for an off-road vehicle user or hiker, are not particularly useful with respect to a substantial amount of information that is highly desirable specifically for off-road vehicle enthusiasts, such as trail conditions for riding, degree of skill needed to traverse the trails, spots or points of interest for off-road vehicle users, and the like. However, maps are not the only instrument available these days for individuals traversing a geographic area.

Modern technology has brought about the ability to identify locations over geographic areas using the Global Positioning Satellite (GPS) system. In fact, there are numerous devices available on the market that will either provide map generation or will provide pin point locations of people or objects on water or land based on GPS positioning. Examples of some of these devices are illustrated in U.S. Pat. No. 4,940,972, No. 5,185,808, No. 5,359,797, No. 5,470,233, No. 5,857,066, No. 5,987,380, No. 6,148,261, No. 6,164,970, No. 6,198,431, No. 6,321,158, No. 6,366,849, No. 6,445,983 and published application No. 2003/0163287. However, such devices can be somewhat sensitive, and off-road vehicle riding, whether by 4×4, ATV, motorcycle, snowmobile, or the like, involves a great amount of vibration and abusive physical movement. This type of movement is not conducive to constant GPS device use.

Therefore, there remains a need for a trail map system or directory that can provide detailed information about off-road trails along with GPS information but is not reliant on a GPS device for operation. Moreover, information pertinent and important to such off-road use is not presently available on existing trail maps or map systems. Consequently, there remains a need in the art for such a device, and the present invention addresses and solves this particular problem in the art.

### SUMMARY OF THE INVENTION

Accordingly, it is one object of the present invention to provide a trail map directory for use with off-highway vehicles.

It is another object of the present invention to provide such a trail map directory which is made up of a plurality of individual maps detailing the off-road trails and which are removable from a binder making up the directory to permit daily use of just one map.

Yet another object of the present invention is to provide such a trail map directory that includes a wealth of information about the trails and the facilities proximate thereto including mines/geological findings, intersecting hiking trails, mountain passes, water crossings, campgrounds, toilets, scenic views and other points of interest.

Still another object of the present invention is to provide a trail map directory for use with off-road vehicles and in particular four-wheel and all-terrain vehicles, which directory is made up of a plurality of individual enhanced topographical maps showing GPS coordinates and having color-coded trail markings to show relative difficulty of use.

To achieve the foregoing and other objects and in accordance with the purpose of the present invention, as embodied and broadly described herein, a trail map directory for off-highway vehicles is disclosed. The directory includes a binder having a plurality of individual map pages laminated for dry ease writing and for ease of cleaning. A mechanism is provided for releasably attaching each map page to the binder. A key map is positioned towards the front of the binder, and the key map is subdivided into individual regional map display portions corresponding to the individual map pages. Each map page is preferably a substantially flat, relatively stiff laminated panel. The panel has first and second faces located on opposite surfaces thereof, and first and second side edges which define the width dimension of the panel. Each panel first face includes an enlarged map display portion indexed relative to the key map and is in the form of an enhanced topographical map overlaid with off-road trails present within the map boundary. The trails are color-coded to indicate relative difficulty of use. The first face further includes trail symbols relative the indicated off-road-trails. Each second face includes an index to the trail symbols appearing on the first face. Finally, an apparatus is disposed along each panel first side edge for releasably attaching the panel to the binder for removal for individual use.

In one modification of the invention, the enhanced topographical map of each removable panel defines a limited geographical area sized for use during a limited duration, off-road vehicle trip. Moreover, the enlarged map display portion of each first face is preferably color indexed relative to the key map. More specifically, one side edge of each panel includes a colored strip disposed therealong and color indexed relative to the key map.

Additionally, the enhanced topographical map preferably includes a shaded topographical map having a three-dimensional appearance on the first face surface. The second face includes GPS coordinates pertinent to the geographical points on the topographical map, and driving directions to the off-road trails.

In another modification, the page attachment mechanism includes a ring binder having a plurality of rings adapted for selective opening and closing. In addition, the first side edge attachment apparatus is in the form of a plurality of apertures disposed along the first side edge of each panel for removable insertion within the plurality of rings when the rings are in an open position.

In another aspect of the invention, the first face further includes text box inserts used to label forest road numbers on the trails, and the second face further includes text box inserts used to clarify directions and features relative to the enhanced topographical map displayed on the first face.

In still another aspect, each enhanced topographical map of each first face enlarged map display portion further includes game management unit numbers for hunters and parking area indicators at the head of each off-road trail present within the map boundary. Additionally, the second face further includes photographs pertaining to the specific off-road trails in the enhanced topographical map appearing on the first face.

In yet another modification of the invention, a map panel is disclosed for use relating to a key map subdivided into individual map display portions corresponding to a plurality of the map panels. The map panel includes a substantially flat panel member having first and second faces. Each first face includes an enlarged map display portion indexed relative to the key map and in the form of an enhanced topographical map overlaid with off-road trails present within the map boundary. The trails are color-coded to indicate relative difficulty of use. The topographical map further includes trail symbols relative to the indicated off-road trails. Finally, each second face preferably includes GPS coordinates pertinent to the geographical points on the topographical map, driving directions to the off-road trails, an index to trail symbols appearing on the first face, and photographs relative to off-road trails in the enhanced topographical map appearing on the first face.

In still another modification of the invention, a book-type map is provided. The book-type map includes a book binder which has a plurality of individual map pages. A mechanism is provided for attaching each map page to the binder. A key map is positioned towards the front of the binder. The key map is subdivided into individual map display portions each covering a small portion of the geographic area covered by the key map, and each corresponding to one of the individual map pages. Each map page includes a substantially flat, relatively stiff panel having first and second faces located on opposite surfaces of the panel, and first and second side edges defining the width dimension of the panel. Each first face includes an enlarged map display portion color indexed relative to the key map and is in the form of an enhanced topographical map overlaid with off-road trails present within the map boundary. The off-road trails are color-coded to indicate relative difficulty of use. The enhanced topographical map further includes trail symbols relative to the indicated off-road trails. Each second face includes GPS coordinates pertinent to the geographical points on the topographical map, driving directions to the off-road trails, an index to trail symbols appearing on the first face, and photographs relative to off-road trails in the enhanced topographical map appearing on the first face. Finally, clear laminate covers each face of each page to provide stiffness to the page and an erasable writing surface for dry ease writing and ease of cleaning.

### BRIEF DESCRIPTION OF THE DRAWINGS

The accompanying drawings which are incorporated in and form a part of the specification illustrate preferred embodiments of the present invention and, together with a description, serve to explain the principles of the invention. In the drawings:

FIG. 1 is a front perspective view of a trail map directory constructed in accordance with the present invention;

FIG. 2 is an enlarged front plan view of the key page in the directory constructed in accordance with the present invention;

FIG. 3 is an enlarged front plan view of a section page indexed to the key page of the directory constructed in accordance with the present invention;

FIG. 4 is an enlarged front plan view of the first face of map page indexed to the section page and key page in the directory constructed in accordance with the present invention; and

FIG. 5 is an enlarged front plan view of the second face of map page indexed to the section page and key page in the directory constructed in accordance with the present invention.

### DETAILED DESCRIPTION OF THE EXEMPLARY EMBODIMENTS

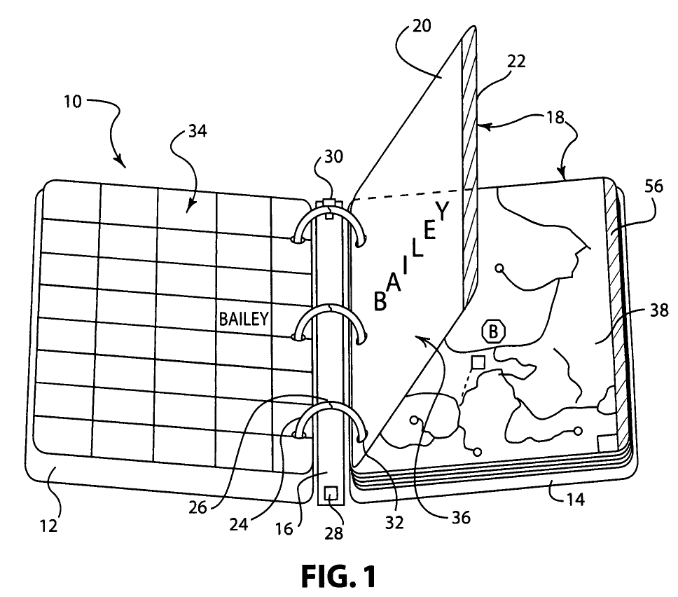

Referring first to FIG. 1, a map directory or booklet 10 preferably includes a front cover 12 and a rear cover 14 interconnected to each other by a binder member 16. The covers 12, 14 and the binder member 16 may be one integral entity or may be separate and interconnected to each other. The cover members 12, 14 may be constructed from any desired material known in the art and is preferably a relatively stiff material such as cardboard, vinyl covered cardboard, plastic and the like.

A plurality of pages 18 are positioned between the covers 12,14. Each page 18 is preferably a substantially flat, relatively stiff laminated panel member having a first or front face 20 and a second or rear face 22. While the individual pages 18 may be permanently mounted to the binder 16, it is preferred that they be removable and detachable therefrom. This arrangement enables corrections and upgrades to be made to an individual map portion contained on a page 18 without having to change and discard the entire directory 10. Moreover, a singular page 18 may be removed from the directory 10 for a limited duration use, such as one or two days, as described below.

To accomplish the above, it is preferred that the binder member 16 include an attachment mechanism in the form of a plurality of ring members 24 of standard and well-known design. Each ring member 24 may be separated at a juncture portion 26, and the opening and closing thereof may be controlled by toggles 28, 30 positioned at each end of the binder member 16. Each page 18 preferably includes a plurality of apertures 32 along one side edge thereof that are positioned for engagement with the ring members 24. In accordance with this well-known construction, the ring members 24 may be separated at their junctures 26 so as to add or remove any number of individual pages 18 and then rejoined to form the closed directory 10. This ring binder arrangement described above is a well-known construction, and further discussion thereof is not deemed necessary herein.

The pages 18 are preferably formed and arranged by function. A key map 34 is preferably positioned towards the front of the binder 10 and may be in the form of a single page or a double page. A section page 36 is provided and preferably indexed to the key map 34, although section pages 36 are not absolutely necessary to accomplish the purposes of the present invention. Finally, a plurality of individual map pages 38 are provided and are indexed relative to the section page 36 and the key map 34. While any form of indexing may be utilized to correlate the map pages 38 with the section pages 36 and the key map 34, color-coding is preferably utilized with the directory 10 of the present invention as described in greater detail below.

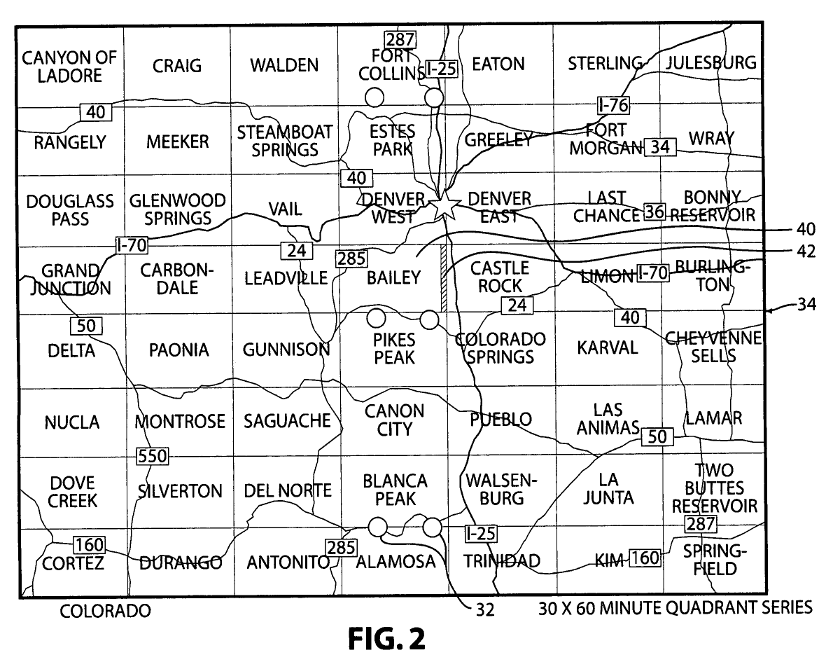

Referring now to FIGS. 1-3, the key map page 34 is illustrated in detail. In this particular example, the directory 10 is an off-road trail map directory for the State of Colorado. Accordingly, the key map page 34 is divided into a grid of regional sections covering the entire state, each section preferably named for a well-known town, city or landmark contained within that particular regional section. In this particular example, there are 56 regional sections identified in the key map 34. The principal highways are outlined on the key map 34.

For illustration purposes only, one specific regional section 40 named Bailey will be utilized and discussed to illustrate the present invention. It should be understood, however, that all of the section pages 36 and map pages 38 relating to the other regional sections of the state function in a similar manner as discussed herein. As can be seen, the Bailey section 40 can be easily located relative to all other sections of the state by referring to the key map 34. A colored indicia stripe 42 is preferably positioned along one edge of the Bailey section 40. In this particular instance, the stripe 42 is yellow. Likewise, all of the other regional sections of the key map 34 have a unique colored stripe along the same side edges thereof for color coding purposes. However, any color arrangement as well as map placement may be utilized as well as other types of indexing such as numbers and the like.

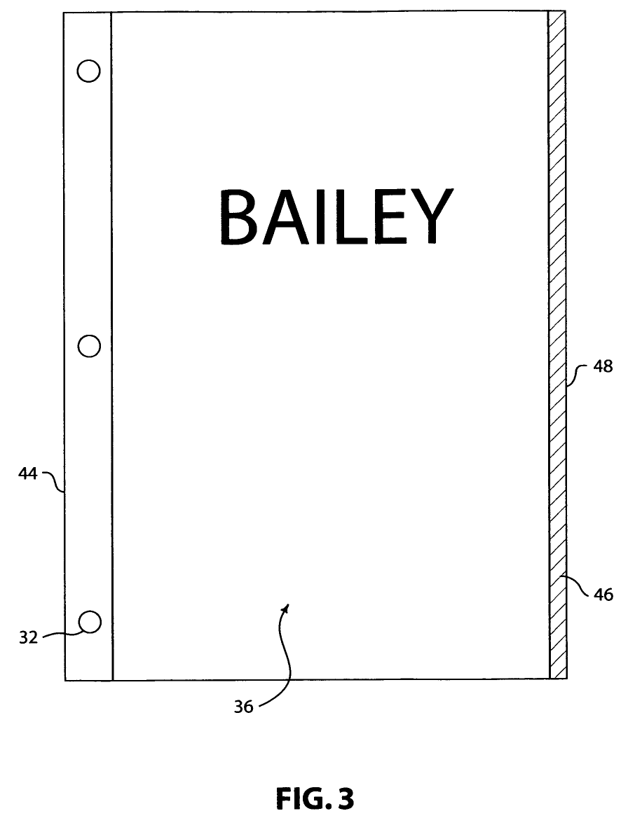

Referring to FIG. 3, the section page 36 is positioned within the binder or directory 10 subsequent to the key map 34. The section page 36 includes the term Bailey and correlates to the Bailey section 40 of the key map 34. While use of the section pages 36 in the directory 10 is optional, their inclusion is nonetheless preferred. In addition, the section page 36 includes a plurality of apertures 32 along a first side edge 44, and a colored indicia stripe 46 along a second edge 48 thereof. It should be understood, however, that the color indicia may appear on any portion of any page 18. In this instance, the stripe 46 is yellow to correspond to the yellow stripe 42 of the Bailey section 40 illustrated in the key map 34. In preferred form, one or more map pages 38 will be positioned subsequent to this section page 36 and which relate to the geographic area bounded by the section 40 of the key map 34.

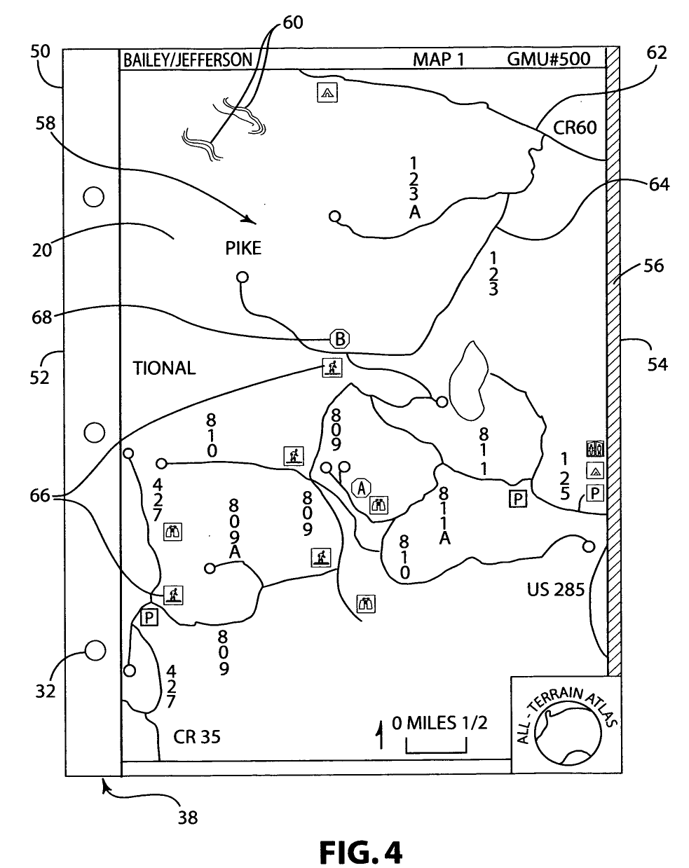

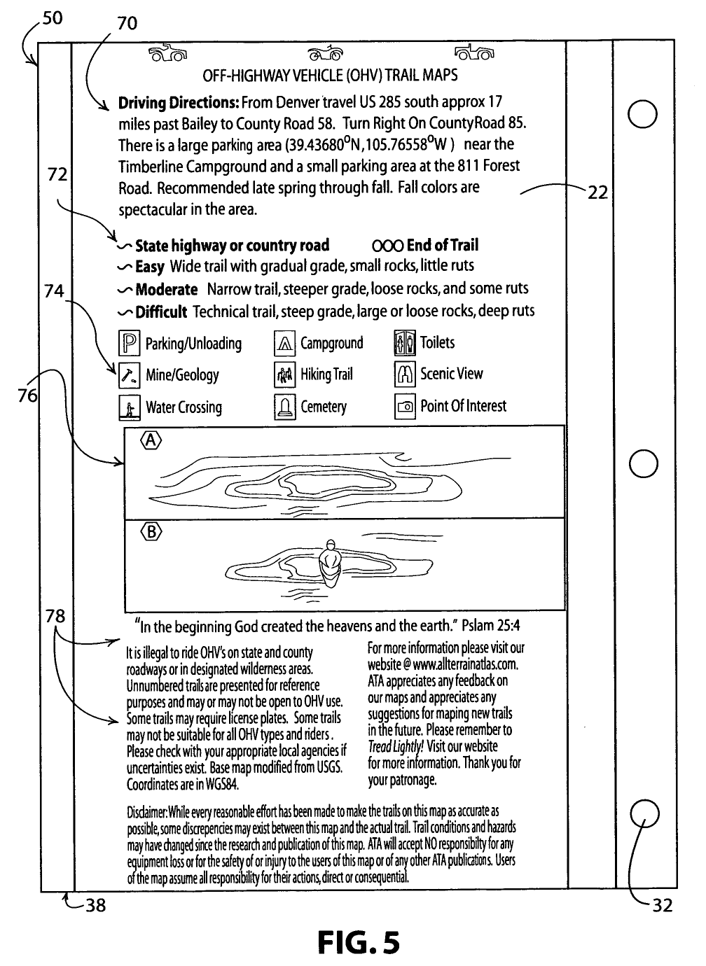

Referring now to FIGS. 4-5, one or more map pages 38 are positioned behind the section page 36 and which detail the geographic topography and trails of the boundary area relating to the section 40 of the key map 34. More specifically, each map page 38 preferably includes a first or front face 20 and a second or rear face 22, although both faces 20 and 22 may appear on one surface of the page 38 in the case of computer downloadable map pages 38. The map page 38, as with the other pages, is preferably a substantially flat, relatively stiff laminated panel member 50 having a first edge 52 and a second edge 54. However, the map page 38 may also be downloadable and printable from a computer web site, in which instance the page 38 is not laminated and may include both faces 20, 22 on one side of a page. Positioned along the second edge 54 is a colored indicia stripe 56 which, in this embodiment, is yellow to correspond to the indicia 46 of the section page 36 and the indicia 42 of the key map 34. In this manner, the several yellow stripes 56, 46 and 42 act to correlate all of the three different map pages as relating to the same geographic boundary area.

The first face 20 of the panel 50 preferably includes an enlarged map display portion 58 in the form of an enhanced topographical map. The topographical lines 60 indicate the relative slope or steepness of the various portions of the map 58. In addition, the topographical map 58 may also include shading surrounding the topographical lines 60 in a manner which provides a three-dimensional appearance on the first face 20. It should be understood that the topographical lines 60 may be excluded in the event shading which provides a three-dimensional appearance is used. In this manner, the steepness of the areas surrounding marked trails can be readily determined by a user of the map page 38. Major highways and paved roads 62 are indicated on the map in one color, preferably red. Off-road trails 64 that are known and within the map boundary are provided along the entire surface of the map 58. The trails 64 are preferably color-coded to indicate relative difficulty of use as determined by the makers of the map directory 10. Specifically, the makers of the map directory 10 travel and inspect the trails 64 in order to provide accurate information in the directory 10. The color coding of the trails 64 preferably range from easy trails for beginners (green), which are wide with gradual grade, small rocks and shallow ruts, to moderate trails for advanced (blue), which are narrow, steeper grade, loose rocks and deeper ruts, to difficult trails for experts (black), which are technical trails with very steep grades, large or loose rocks and very deep ruts.

In addition, trail symbols 66 are provided which relate information for users of the directory 10 and travelling the off-road trails 64. Examples of such trail symbols include parking/unloading areas, campgrounds, toilets, mines/geological formations, hiking trails, scenic views, water crossing, cemetery and points of interest. In addition to the above, the first face 20 may further including text box inserts used to label forest road numbers on the trails as well as game that management unit numbers for hunters. Moreover, indicia 68 are provided as a reference for photographs of appearing on the second face 22 of the map page 38 as described below. Finally, end of trail and trail closures are first verified by the makers of the directory 10 and then provided on the map 58.

The panel 50 also includes a plurality of apertures 32 along the first side edge 52 on order to permit releasable attachment of the map page 38 to the binder member 16. In this manner, the map page 38 may be removed from the directory 10 and taken out alone for an off-road trail ride of a limited time duration, such as one or two days, thereby eliminating the necessity to carry the entire directory on a compact ATV or motorcycle.

FIG. 5 illustrates the second face 22 of the panel 50. The second or rear face 22 of the panel 50 preferably includes GPS coordinates pertinent to the specific geographical points on the topographical map 58. The GPS coordinates may be provided as a starting point at a trail head or in the event that an individual wanders off the marked trail 64 and needs to obtain a reference relative to the map 58. Driving directions 70 are also provided from a major population center to the trail heads indicated on the first face 20. In addition, the second face also preferably includes an index 72 as to the trail color-coding difficulty rating as well as an index 74 to the trail symbols 66 used on the first face 20 of the map 38. In the preferred embodiment, the second face 22 of the map page 38 also includes one or more photographs 76 of areas that can be seen from the trails 64 marked on the first face 20. The indicia 68 on the first face 20 of the page 38 indicate the points where the photographs were shot and which can be observed by a person traveling the trails 64 and using the directory 10. Finally, other text boxes 78 may selectively be included to provide a biblical or inspirational quote, to clarify directions or geographical features, and the like.

As can be seen from the above, the present invention provides a unique off-highway map directory or booklet for use by off-road vehicle operators. This particular invention is especially useful for individuals operating four-wheel drive vehicles, all-terrain vehicles, dirt motorcycles, mountain bikes, snowmobiles as well as for cross-country skiers, hikers and the like. The directory of the present invention provides detailed off-road trail maps illustrating not just the trails, but the relaive difficulty of the trails, the various points of interest or information available along the trails, and the like. It also provides GPS coordinates relating to the trails as well as topographical information of the countryside through which the trails traverse. The directory may be used in its entirety, or a single individual map may be readily removed for daily use. All the maps of the directory are laminated and indexed relative to each other to make use of the directory simple yet effective.

The foregoing description and the illustrative embodiments of the present invention have been described in detail in varying modifications and alternate embodiments. It should be understood, however, that the foregoing description of the present invention is exemplary only, and that the scope of the present invention is to be limited to the claims as interpreted in view of the prior art. Moreover, the invention illustratively disclosed herein suitably may be practiced in the absence of any element which is not specifically disclosed herein.

We claim:

1. A trail map directory for off-highway vehicles comprising:
a binder having a plurality of individual map pages laminated for dry ease writing and ease of cleaning;
a mechanism for releasably attaching each said map page to said binder;
a key map positioned towards the front of said binder, said key map being subdivided into individual regional map display portions corresponding to said individual map pages;
each said map page comprising a substantially flat, relatively stiff laminated panel having first and second faces located on opposite surfaces of said panel and first and second side edges defining one dimension of said panel, each said first face including an enlarged map display portion indexed relative to said key map and in the form of an enhanced topographical map overlaid with off-road trails present within the map boundary and color-coded to indicate relative difficulty of use, and further including trail symbols relative to the indicated off-road trails, and each said second face including an index to said trail symbols appearing on said first face; and
an apparatus disposed along each said panel first side edge for releasably attaching said panel to said binder for removal for individual use.

2. The directory as claimed in claim 1, wherein the enhanced topographical map of each said removable panel defines a limited geographical area sized for use during a limited duration, off-road vehicle trip.

3. The directory as claimed in claim 1, wherein the enlarged map display portion of each said first face is color indexed relative to said key map.

4. The directory as claimed in claim 3, wherein said one side edge of each said panel includes a colored strip disposed therealong.

5. The directory as claimed in claim 1, wherein said enhanced topographical map comprises a shaded topographical map having a three-dimensional appearance on said first face surface, and wherein said second face includes GPS coordinates pertinent to the geographical points on said topographical map and driving directions to said off-road trails.

6. The directory as claimed in claim 1, wherein said page attachment mechanism comprises a ring binder having a plurality of rings adapted for selective opening and closing, and wherein said first side edge attachment apparatus comprises a plurality of apertures disposed along said first side edge of each said panel for removable insertion within said plurality of rings when said rings are in an open position.

7. The directory as claimed in claim 1, wherein said first face further includes text box inserts used to label forest road numbers on said trails, and said second face further includes text box inserts used to clarify directions or features relative to the enhanced topographical map displayed on said first face.

8. The directory as claimed in claim 1, wherein each said enhanced topographical map of each said first face enlarged map display portion further includes game management unit numbers for hunters and parking area indicators at the head of each off-road trail present within said map boundary, and wherein said second face further includes photographs pertaining to the specific off-road trails in the enhanced topographical map appearing on said first face.

9. A map panel relating to a key map subdivided into individual map display portions corresponding to a plurality of said map panels, said map panel comprising a substantially flat panel member having first and second faces, said first face including an enlarged map display portion indexed relative to the key map and in the form of an enhanced topographical map overlaid with off-road trails present within the map boundary, the trails being color-coded to indicate relative difficulty of use, and further including trail symbols relative to the indicated off-road trails, and said second face including GPS coordinates pertinent to the geographical points on said topographical map, driving directions to said off-road trails, an index to trail symbols appearing on said first face, and photographs relative to off-road trails in the enhanced topographical map appearing on said first face.

10. The map panel as claimed in claim 9, wherein said panel is laminated and said first and second faces are located on opposite surfaces of said laminated panel member with first and second side edges defining one dimension of said panel member, and wherein said panel further comprises an apparatus disposed along said panel first side edge for releasably attaching said panel to a binder for removal for individual use.

11. The map panel as claimed in claim 10, wherein the binder includes a plurality of rings adapted for selective opening and closing, and wherein said first side edge attachment apparatus comprises a plurality of apertures disposed along said first side edge of said panel for removable insertion within the plurality of rings when the rings are in an open position.

12. The map panel as claimed in claim 9, wherein the enhanced topographical map of each said removable panel defines a geographical area sized for use during a limited duration, off-road vehicle trip thereby enabling a person to use only one panel at a time.

13. The map panel as claimed in claim 9, wherein the enlarged map display portion of said first face is color indexed relative to the key map, and said enhanced topographical map comprises a shaded topographical map having a three-dimensional appearance on said first face surface.

14. The map panel as claimed in claim 9, wherein said first face further includes text box inserts used to label forest road numbers on said trails, game management unit numbers for hunters, and parking area indicators at the head of each off-road trail present within said map boundary, and wherein said second face further includes text box inserts used to clarify directions or features relative to the enhanced topographical map displayed on said first face.

15. A book-type map comprising:
a book binder having a plurality of individual map pages;
a mechanism for attaching each said map page to said binder;
a key map positioned towards the front of said binder, said key map being subdivided into individual map display portions each covering a small portion of the geographic area covered by said key map and each corresponding to one of said individual map pages;
each said map page comprising a substantially flat, relatively stiff-panel having first and second faces located on opposite surfaces of said panel and first and second side edges defining the width dimension of said panel, each said first face including an enlarged map display portion color indexed relative to said key map and in the form of an enhanced topographical map overlaid with off-road trails present within the map boundary and color-coded to indicate relative difficulty of use, and further including trail symbols relative to the indicated off-road trails, and each said second face including GPS coordinates pertinent to the geographical points on said topographical map, driving directions to said off-road trails, an index to trail symbols appearing on said first face, and photographs relative to off-road trails in the enhanced topographical map appearing on said first face; and
clear laminate covering each said face of each said page to provide stiffness to said page and an erasable writing surface for dry ease writing and ease of cleaning.

16. The book-type map as claimed in claim 15, wherein said book binder includes a plurality of individual laminated section pages, each said section page being color coded and titled to correspond to one said individual map display portion of said key map.

17. The book-type map as claimed in claim 15, wherein said enhanced topographical map comprises a shaded topographical map having a three-dimensional appearance on said first face surface.

18. The book-type map as claimed in claim 17, wherein each said map page panel further comprises an apparatus disposed along each said panel first side edge for releasably attaching said panel to said binder to permit selective removal for individual use. And wherein said enhanced topographical map of each said removable panel defines a geographical area sized for use during a limited duration, off-road vehicle trip.

19. The book-type map as claimed in claim 18, wherein said first face further includes text box inserts used to label forest road numbers on said trails, and said second face further includes text box inserts used to clarify directions or features relative to the enhanced topographical map displayed on said first face.

20. The book-type map as claimed in claim 19, wherein each said enhanced topographical map of each said first face enlarged map display portion further includes game management unit numbers for hunters and parking area indicators at the head of each off-road trail present within said map boundary.
